(19) United States
(12) Patent Application Publication
(10) Pub. No.: US 2012/0278144 A1
(43) Pub. Date: Nov. 1, 2012

(54) IMAGING APPARATUS ELECTRONIC ASSISTANT

(75) Inventors: Robert Popilock, Hudson, OH (US); Matthew J. Walker, Willoughby, OH (US)

(73) Assignee: KONINKLIJKE PHILIPS ELECTRONICS N.V., EINDHOVEN (NL)

(21) Appl. No.: 13/512,032

(22) PCT Filed: Dec. 7, 2010
(86) PCT No.: PCT/IB10/55631

§ 371 Date: May 25, 2012

Related U.S. Application Data
(60) Provisional application No. 61/288,473, filed on Dec. 21, 2009.

(51) Int. Cl. G06K 9/00; G06Q 30/02

(52) U.S. Cl. 705/14.4; 382/131; 382/115

(57) ABSTRACT

A method includes presenting, via a display (118) of an imaging apparatus (100), information for a person interacting with the imaging apparatus. A system includes an imaging apparatus (100) with a patient examination region (106) and a display (118) for presenting information, a console (116) that controls an operation of the imaging apparatus (101), and an electronic assistant (120) that selects one or more programs from pre-recorded electronic media (210) stored in an electronic media library (208), wherein the one or more programs are presented via the display (118).

The following generally relates to an electronic assistant for an imaging apparatus and finds particular application to computed tomography (CT). However, it also amenable to other imaging modalities such as magnetic resonance (MR), positron emission tomography (PET), single photon emission computed tomography (SPECT), x-ray radiography (X-Ray), ultrasound (US), and/or other imaging modalities.

A multi-slice computed tomography (CT) scanner includes an x-ray tube mounted on a rotatable gantry that rotates around an examination and an object or subject therein. The x-ray tube emits radiation that traverses the examination region and the object or subject. A detector detects radiation that traverses the examination region and generate projection data indicative thereof. A reconstructor processes the projection data and reconstructs three-dimensional (3D) volumetric image data indicative thereof. The volumetric image data is processed to generate one or more images of the examination region, including the portion of the subject or object disposed therein.

The following presents a generalized example of the process of scanning a patient with the above or other imaging apparatus. Assuming that a patient is scheduled for an imaging examination with the above scanner, the process typically begins with the patient checking in at the Admissions and/or Radiology Department check in desk. Once checked in, the patient is asked to wait in a waiting area. If the imaging examination requires ingestion of a contrast agent (or other pre-exam action) by the patient, a radiology technician (or other authorized personnel) prepares the agent, gives it to the patient, and instructs the patient regarding ingestion. When the patient is ready to be imaged, the radiology technician escorts the patient to the examination room.

Before scanning the patient, the radiology technician confirms the identification of the patient, explains the imaging examination to the patient, and instructs the patient with proper positioning on the patient support for the examination. The radiology technician then sets up the system for scanning the patient via a workstation. This may include selecting the patient from a list of patients, selecting the examination from a list of different examinations, and setting scan parameters. The radiology technician then performs the examination, giving instructions during the examination (e.g., deep breath, hold, let it out), if needed. Once finished, the radiology technician may remain at the workstation for a several minutes to ensure that the region of interest is suitable captured in the images and then escorts the patient back to the front desk.

Unfortunately, during the time (e.g., up to 20 minutes) the radiology technician is setting up the system for scanning, the patient is often in the examination room by him/herself and is asked to lie still since they may have been positioned based on the particular examination. Similarly, once the examination is finished the patient often has to wait for the radiology technician to ensure the region of interest is in the images. Such waiting may lead to scanning inefficiencies and provide the patient with poor examination experience. Furthermore, the technician may have to go back and forth to the scanning room from the console room several times to obtain information from the patient that may affect one or more scan parameters and/or the examination, adding to the examination time. Moreover, the patient may be anxious or may not speak the language of the technician. Such anxiety may be due to the nature of the scan, the condition of the patient, or the age of the patient. This may add to the time it takes to prepare the patient for the examination, set up the examination, and perform the examination. This may also affect the outcome of the examination (e.g., the information captured in the images) as the patient may not have been able to comprehend or follow instructions delivered prior to scanning In one instance, this may lead to having to re-scan the patient or postpone the examination, which, in the case of CT scanning, would result in the deliver of an undesired incremental ionizing radiation.

Aspects of the present application address the above-referenced matters and others.

According to one aspect, a method includes presenting, via a display of an imaging apparatus, information for a person interacting with the imaging apparatus.

According to another aspect, a system includes an imaging apparatus with a patient examination region and a display for presenting information, a console that controls an operation of the imaging apparatus, and an electronic assistant that selects one or more programs from pre-recorded electronic media, wherein the one or more programs are presented via the display.

According to another aspect, a computer readable storage medium contains instructions which, when executed by a computer, cause the computer to perform the acts of: selecting a program to present to a patient of an imaging apparatus based on information about the patient and presenting the program via a display of the imaging apparatus.

The invention may take form in various components and arrangements of components, and in various steps and arrangements of steps. The drawings are only for purposes of illustrating the preferred embodiments and are not to be construed as limiting the invention.

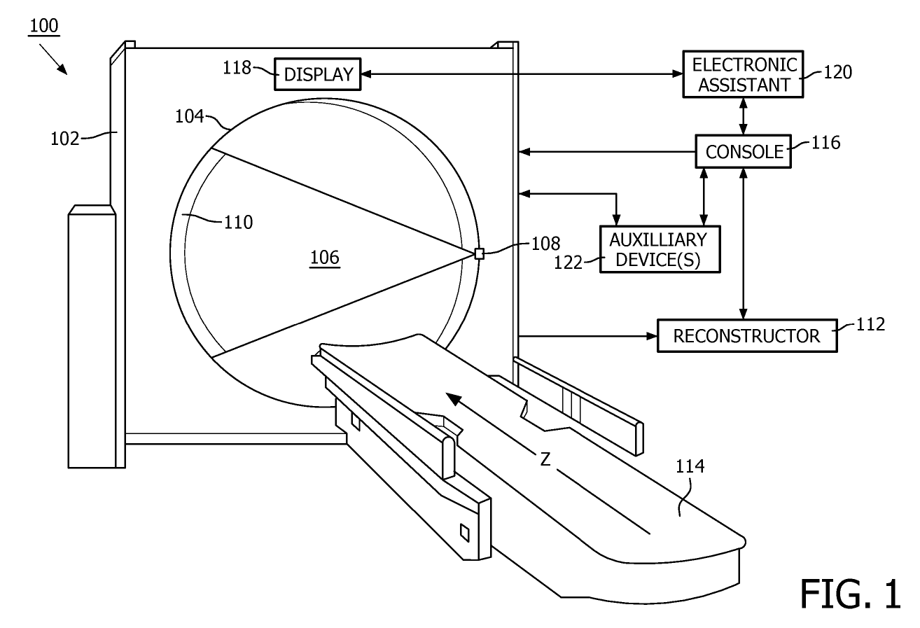

FIG. 1 illustrates an electronic assistant in connection with an imaging apparatus.

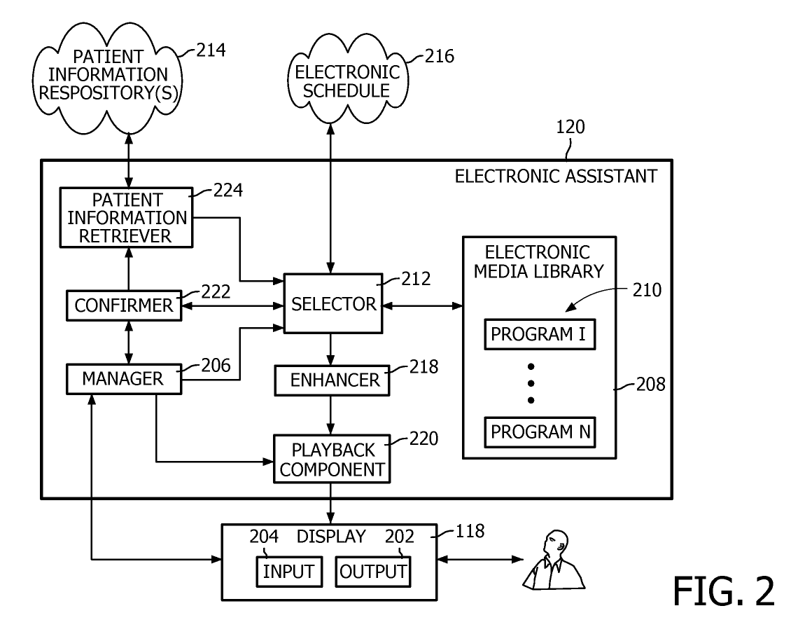

FIG. 2 illustrates an example electronic assistant.

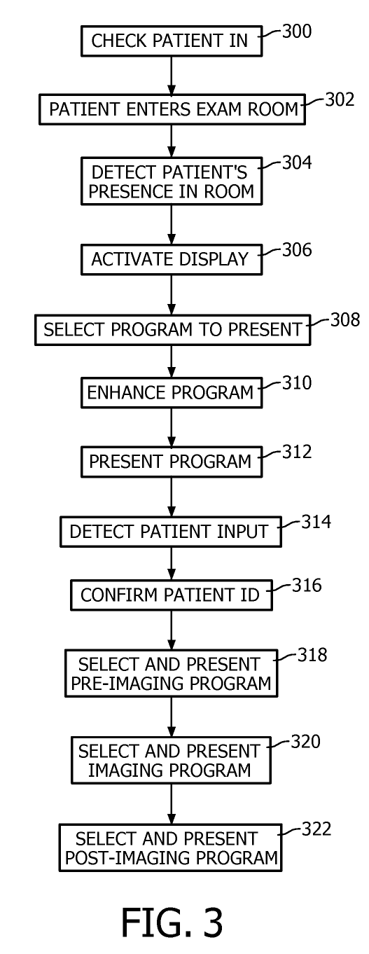

FIG. 3 illustrates an example of using the electronic assistant with scanning a patient.

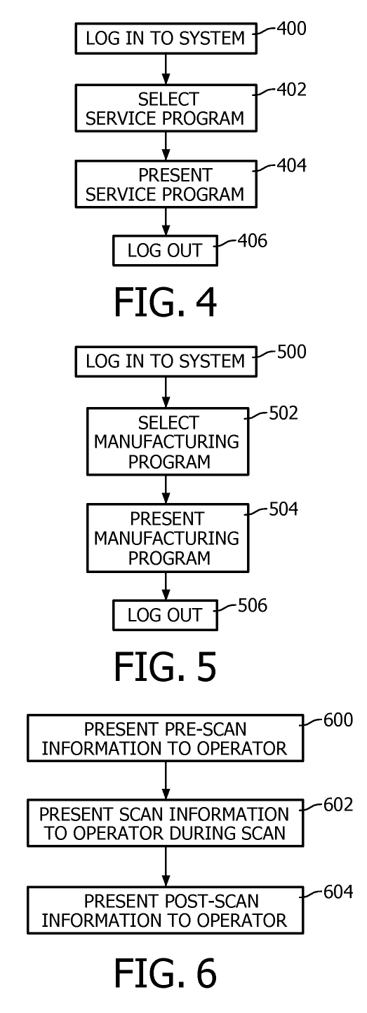

FIG. 4 illustrates an example of using the electronic assistant to assist a service technician.

FIG. 5 illustrates an example of using the electronic assistant to assist a manufacturing technician.

FIG. 6 illustrates an example of using the electronic assistant to assist a radiology technician.

The following generally relates to an electronic assistant and is discussed in the context of providing pre- through post-imaging examination information to a patient. As described in greater detail below, the electronic assistant can be used in conjunction with a display(s) for presenting certain information to the patient and/or receiving information from the patient, which may be used in determining the information presented to the patient.

The electronic assistant can be used with various imaging modalities such as computed tomography (CT), magnetic resonance (MR), positron emission tomography (PET), single photon emission computed tomography (SPECT), x-ray radiography (X-Ray), ultrasound (US), and/or other imaging modalities. However, for sake of brevity and explanatory purposes, the electronic assistant is described herein in connection with a CT imaging apparatus.

FIG. 1 illustrates a system including an imaging apparatus 100 and an electronic assistant 120. The imaging apparatus 100 includes a generally stationary gantry 102 and a rotating gantry 104. The rotating gantry 104 is rotatably supported by the stationary gantry 102 and rotates around an examination region 106 about a longitudinal or z-axis. A patient support 114, such as a couch, supports an object or subject such as a human patient in the examination region 106.

A radiation source 108, such as an x-ray tube, is supported by the rotating gantry 104. The radiation source 108 emits radiation from a focal spot and the radiation traverses the examination region 106. A radiation sensitive detector array 110 subtends an angular arc opposite the radiation source 108 across the examination region 106, detects radiation traversing the examination region 106, and generates projection data indicative thereof. A reconstructor 112 reconstructs the projection data and generates three-dimensional (3D) volumetric image data indicative thereof.

A general-purpose computing system or computer serves as an operator console 116. A processor of the console 116 executes computer readable instructions encoded on computer readable storage medium of the console 116, which allow an operator to control an operation of the system 100. One or more auxiliary devices 122 such as an ECG monitor, an injector, an insufflator, etc. can be used in connection with the system 100. Such devices can be configured to communicate with the system 100 and/or the console 116. In one instance, the system 100 and/or console 116 can control (e.g., activate) such devices and/or receive information (e.g., signals, parameters, etc.) from one or more of these devices.

A display 118 presents selected information, for example, imaging examination information to a patient, physician, and/or radiology technician, service related information to a service technician, manufacturing related information to a manufacturing technician, etc. In one instance, the display 118 is also configured to receive information, for example, an input from a person such as a patient, a physician, a radiology technician, a service technician, and/or a manufacturing technician. The input information may be used in determining the selected information. As such, the display 118 can be an interactive display configured for interacting with people.

The illustrated display 118 is located within a mid-region of the stationary gantry 102 above the examination region 106. In other embodiments, the display 118 is otherwise located, for example, to the left or right and/or above or below the illustrated display 118. In addition, the system 100 may include more than one display 118. The illustrated size and shape are provided for explanatory purposes and are not limiting; other size and shaped displays are also contemplated herein. In another embodiment, the display 118 is removeably affixed to the system 100, for example, via a docking station on the stationary gantry 102, and includes at least one of a wire or wireless communications port, and communicates with the system 100 via a cable or wirelessly. In yet another embodiment, the display 118 is supported by a moveable mechanical arm.

An electronic assistant 120 is in electrical communication with the display 118 and/or the console 116. The illustrated electronic assistant 120 is an interactive electronic assistant that can be used conjunction with the display 118. As described in greater detail below, the electronic assistant 120 can select information that is presented via the display 118 and the selected information may be based no input received by the display 118 and/or otherwise. In one instance, the electronic assistant 120 is used facilitate presenting imaging examination information (and/or other information) before, during, and/or after an imaging examination to a patient. In another instance, the electronic assistant 120 is used to provide assistance to one or both of a service technician or a manufacturing technician.

When used to present imaging examination information to a patient, a radiology technician (or other authorized person) can prepare the imaging apparatus 100 for scanning the patient concurrently as the interactive electronic assistant 120 goes over various information with the patient such as verifying the patient's identification, explaining the examination, providing instructions for the examination, etc. This may reduce the amount of time a patient is in the examination room, which may improve the examination experience for the patient. Moreover, the information presented to the patient may depend on various factors such as patient age, a language of the patient, and/or other patient specific information, which may facilitate reducing any patient anxiety and/or improving the likelihood that the instructions will be followed. Furthermore, the information presented can be used to facilitate patient verification.

It is to be appreciated that the electronic assistant 120 may be part of or integrated with a computing device (e.g., a computer) having one or more processors that execute one or more instructions encoded or stored on computer readable storage medium to implement the functions thereof. In one instance, the electronic assistant 120 is included in the gantry 102. In another instance, the electronic assistant 120 is part of the console 116. In yet another instance, the electronic assistant 120 resides in a computing device remotely located from the imaging apparatus 100.

FIG. 2 illustrates an example of the display 118 and the electronic assistant 120. The components of the display 118 and the electronic assistant 120 are generally discussed here, and then further discussed in operation via use-case scenarios in FIGS. 3, 4, and 5.

As shown in FIG. 2, in one embodiment the display 118 includes both an output region 202 and an input region 204 respectively for presenting information and receiving information. In another embodiment, the display 118 only includes the output region for presenting information. The output region 202 may include, but is not limited to, one or more of a liquid crystal display (LCD), a plasma display, a cathode ray tube (CRT), a light emitting diode (LED), and/or other output technology, including but not limited to haptic feedback-capable devices and/or other devices. The input region 204 may include, but is not limited to, one or more of an audio receiver, an imaging device (e.g., camera, video recorder, scanner, etc.), a touch screen, and/or other input technology. The display 118 can be used to present information to a patient and/or receive information from the patient as further discussed below.

The electronic assistant 120 includes a manager 206 that manages and/or otherwise controls various components of the electronic assistant 120. For example, the manager 206 can turn the display 118 on and off, activate and/or invoke various components of the electronic assistant 120 to perform various functions, deactivate components (e.g., to halt the examination from continuing until an operator override is received, to transition the display to a lower power mode such as sleep, hibernate, off, etc.), coordinate operation of the electronic assistant 120, etc. This will be described in greater detail later in conjunction with below use-case examples.

An electronic media library 208 stores various pre-recorded electronic media such as one or more programs 210 that can be individually, concurrently, sequentially and/or otherwise accessed and presented via the display 118 or other device. A program 210 may include, but is not limited to, variously formatted information such as one or more of a still picture, motion picture (video), animation, computer graphics, text, etc. In another embodiment, the electronic media library 208 is located remote from the electronic assistant 120.

A selector 212 selects (and/or identifies) one or more programs 210 from the library 208 for display based on various information. For example, in one instance the selector 212 selects a default program. By way of example, the same greeting may be presented to each patient. In another instance, the selector 212 selects an informational and/or instructional program that correspond to patient demographics (e.g., age, gender, race, language, etc.), patient history (e.g., medical, family, imaging, etc.), a type of imaging examination being performed, a primary language of the patient, and/or other information. In another instance, the selector 212 selects information based user preferences, a facility policy, and/or other criteria.

Patient demographics, medical history, family history, imaging history, spoken language, etc. can be obtained from one or more patient information repositories 214 (e.g., a hospital information system (HIS), a radiology information system (RIS), etc.) and/or other electronic storage. The type of imaging examination can be obtained from an electronic schedule 216 and/or otherwise. In still other instance, the selector 212 selects programs that include commercials, advertisements, movies, cartoons, music, alerts, warnings, and/or other electronic information.

An enhancer 218 is configured to enhance or supplement a selected program. For instance, a selected default greeting can be enhanced to include a patient's name, which can be retrieved from the electronic schedule 216, for example, as the name of the patient scheduled at that time for an examination. The enhancer 218 can also enhance other program with other information. In another embodiment, the enhancer 218 is omitted.

A playback component 220 conveys the program and/or enhanced program to the display 118 for presentation.

A confirmer 222 confirms various information. For example, the confirmer 222 can confirm that the correct patient is in the examination room. For example, the confirmer 222 can retrieve the name of the scheduled patient from the electronic schedule 216 or the selector 212 (as shown) and confirm the name of the patient with a name provided by the patient and received by the input region 204. The confirmer 222 can notify the manager 206, the selector 212, and/or other component regarding whether the names matches or not. By way of example, the confirmer 222 can notify the selector 212 of a match so that the selector 212 can select a next program to display based one the patient and/or patient information. By way of another example, the confirmer 222 can notify the radiology technician via the display 118 and/or otherwise if the match is unsuccessful.

A patient information retriever 224 retrieves information about the patient. In one instance, the patient information retriever 224 retrieves information in response to the confirmer 222 confirming that the correct patient is in the exam room. The retrieved information can be provided to the selector 212, which can use the information to facilitate selecting a program to display and/or pass the information along to the enhancer 218, which can enhance the selected program with the retrieved information.

The display 118 can also be used to present information for and/or interact with an operator of the apparatus 100 (e.g., such as instructions, alerts, etc.), a service technician servicing the apparatus 100, manufacturing personnel manufacturing the apparatus 100, and/or other entities. In these instances, the library 208 additionally or alternatively includes programs relating to operating the apparatus 100, servicing the apparatus 100, and/or assembling the apparatus 100, and the manager 206 and selector 212 facilitate providing suitable information to the recipient interacting with the display 118.

FIG. 3 illustrates a non-limiting example use-case scenario for using the electronic assistant 120 to facilitate scanning a patient. It is to be appreciated that the particular ordering of the below acts are not limiting. As such, in other embodiments, the acts can be otherwise ordered. In addition, one or more of the acts may be omitted and/or one or more acts can be included. Also note that the particular acts may be dependent upon the patient. For example, the electronic assistant 120 may behave different depending on whether the patient is mobile or bed ridden, the age of the patient, etc.

At 300, a patient scheduled for an imaging examination is checked in for the examination. Where the patient is an outpatient, the patient can check in at a computing terminal and/or through authorized personnel (e.g., in person, over a phone, etc.). Where the patient is an inpatient, hospital personnel and/or other authorized personnel may check the patient in. Upon being checked in, the patient may have to wait in a waiting room or other known area where the radiology technician can locate the patient.

At 302, a patient enters the exam room where the imaging apparatus 100 is located. For an ambulatory/mobile patient, this may include having the patient walk into the room or wheeled into the room via a wheel chair. For a non-mobile patient, this may include having the patient wheeled into the room via a portable patient bed, a transportation cart, a wheel chair, and/or other transporting apparatus.

At 304, the input region 204 of the display 118 (or other device) detects that the patient entered the room and generates a signal indicative thereof. In one instance, the input region 204 includes a motion sensor, an infrared sensor, an audio sensor, and/or other sensor that can be used to detect the presence of the patient. In another embodiment, the sensor is omitted, and the radiology technician operating the system 100 provides an input (e.g., a key press, a mouse click, etc.) via the console 116 that generates a signal that indicates the patient is in the examination room. In another embodiment, the patient scans their hospital ID.

At 306, the display 118 is activated (or turned “on”) in response to the signal. For example, the manager 206 can activate the display 118, including selectively activating one or more of the components of the output 202 and/or input regions 204, in response to receiving a signal from the input region 204 indicating that a person is in the room.

At 308, the selector 212 selects one or more programs for presentation via the display 118. In this example, the initial program is a default program such as a default greeting followed by a request for or validation of the patient's name. Where the patient is child, the selected program may include a virtual (animated or cartoon) radiologist and/or other child-based programming The patient's age can be determined via the electronic schedule 216, the patient, a guardian of the patient, the radiology technician, and/or otherwise.

At 310, the selected program is optionally enhanced or supplemented by the enhancer 218.

At 312, the program is sent to the playback device, which streams the program to the display 120. In this example, the greeting is played and the patient is asked to provide their name.

At 314, the response of the patient to the request is detected. A patient response can detected through various approaches. For example, in one instance, the system detects audio responses and detects a patient speaking his/her name. Additionally or alternatively, the system is configured for a tactile response, for example, via one or more touch screen buttons, and the patient selects or presses a touch screen button confirming or rejecting a candidate name. In this instance, the patient can touch a button using a finger, a digital pen, a mouse pointer, etc. Where the input region 204 includes an identification band scanner, a biometric scanner (e.g., facial, cornea, fingerprint, etc), and/or other scanner, the patient can be asked to place the appropriate article and/or anatomy within the scanner's reading field.

If no response is received within the predetermined period of time, the program is played back one or more times. If a response still is not detected, then the program can notify the radiology technician that assistance is needed. For the latter, this may include presenting a verbal and/or graphical message via the display 118 and/or console 116, and/or notify the radiology technician via a pager, telephone, a cell phone, a personal data assistant, an email message, and/or otherwise.

At 316, the identification of the patient is confirmed. For example, scheduled patient identification can be obtained and compared with the patient name provided by the patient.

At 318, once the patient is confirmed, the selector 212 selects a next one or more programs for presentation via the display 118. The particular program may selected based on various information such as the particular examination being performed, patient information demographics, languages spoken and/or understood by the patient, patient medical history, patient imagines history, and/or other information. In one instance, the next program requests information that may affect how the examination proceeds. Such information may include information related to whether the patient is pregnant, has any metal in their body, has had cancer, is in good health, does not have a contrast allergy, has to go to the bathroom, hasn't eat in the past eight hour, etc.

Additionally or alternatively may include the video or virtual radiologist discussing various aspects of the imaging procedure with the patient. This may include explaining the imaging procedure, such as identifying the region of the patient that is being scanned, noting approximately how long the imaging procedure should take, apprising the patient of any actions that they may need to perform during the procedure (e.g., hold breath, turn, position arms over head, etc.), etc. Additionally or alternatively, the program may include instructions such as instructions instructing the patient on how to lie down (e.g., supine, prone, on a side, etc.) on the patient support 114 and to go ahead and lie down.

At 320, for scanning, the selector 212 can again select a program for presentation via the display 118. This program may include examination instructions (e.g., hold breath, release breath, etc.), a movie, a cartoon, play, advertisements, commercials, etc. In another instance, the display 118 transitions to an idle mode during scanning

At 322, after the exam, the selector 212 can again select a program for presentation via the display 118. In one instance, this program may include a survey regarding the examination. A suitable survey may include questions about the patient's experience, such as a rating indicative of one or more of the presented informational information and/or instructional information, any communication with the radiology technician, the time length of the procedure, etc. The post-exam program may also instruct the patient the he/she can get off of the table and go to the front desk or waiting area.

It is to be appreciated that where the display 118 is removably affixed to the system 100 and includes wireless technology for wirelessly communicating with the controller 120, the patient can be given the display 118 in the waiting area and the display 118 can present certain information to the patient in the waiting area. When the patient enters the exam room, the display 118 can be inserted into a docking station or the like.

FIG. 4 illustrates another non-limiting use-case. For this embodiment, the display 118 is used to facilitate a service technician servicing the system 100. Again, the particular acts and the ordering thereof are not limiting and can be otherwise.

At 400, a service technician identifies him/herself to the system 100. This may include logging into the console 120 and/or display 118, toggling a mode of the system 100 to a service mode via a key, voice or other bio-metric recognition, communicating with the system 100 via a computing device such as a laptop or other device, etc.

At 402, one or more service related programs are selected by the selector 212. This may include selecting a program based on the particular type of service (e.g., preventive maintenance, corrective maintenance, calibration, etc.) indentified by the service technician, scheduled service, a default setting, the particular service technician, a service technician identified program, and/or other program. The program may include troubleshooting tips, step-by-step repair instructions, a service history log, service notes, etc. In another embodiment, the service technician may scan the bar code of a part to drive part replacement content and log of part serial number. The former provides replacement guidance and support and the latter supports system auditing, recall, and cost of repair.

At 404, the one or more service related programs are presented to the service technician via the display 118.

At 406, upon concluding service, the service technician can interact with the display 118, for example, to communicate information such as the type(s) of service that was performed, a service technician identification, a rating of how helpful the presented information was during service, etc., and log out.

FIG. 5 illustrates another non-limiting use-case. For this embodiment, the display 118 is used to facilitate manufacturing personnel. It is assumed that a system 100 has been assembled at least up to a point where the display 118 and electronic assistant 120 has been installed and are operational. Again, the particular acts and the ordering thereof are not limiting and can be otherwise.

At 500, a manufacturing technician identifies him/herself to the system 100. This may include logging into the console 120 and/or display 118, toggling a mode of the system 100 to a service mode via a key, voice or other bio-metric recognition, communicating with the system 100 via a computing device such as a laptop or other device, etc.

At 502, one or more manufacturing related programs are selected by the selector 212. This may include selecting a program based on particular hardware being installed, a calibration routine, etc. The program may include tips, a notes, manuals, etc. In another embodiment, purchase order details can be viewed to ensure the manufactured configuration matches the customer's request.

At 504, one or more manufacturing related programs are presented to the manufacturing technician via the display 118. This may include selecting a program based on particular hardware being installed, a calibration routine, etc. The program may include tips, a notes, manuals, etc.

At 506, upon concluding assembling and calibrating the system 100, the display 118 can provide information via the display 118 and/or otherwise receive information such as calibration results, manufacturing personnel identification, a rating of how helpful the presented information was during assembly, etc., and log out

FIG. 6 illustrates another non-limiting use-case. For this embodiment, the display 118 is used to facilitate a radiology technician performing a scan

At 600, optionally, the selector 212 selects one or more programs to present to the operator (e.g., radiology technician or other authorized entity) of the apparatus 100 via the display 118 prior to an imaging procedure. The information in such programs may relate to entering scan parameters, setting up an auxiliary device such as an ECG monitor, an injector, an insufflator and/or other device, triggering the apparatus to scan a patient, etc. By way of example, the information may provide instructions on how and where to connect ECG leads. The information may additionally or alternatively include error messages, warning, alert, notifications, etc. By way of example, the information may provide a message indicating the one or more ECG leads may not be correctly connected to the patient. By way of non-limiting example, the information may provide interaction means for a radiology technician to select and/or verify protocol selection, for example, in pediatric patients (e.g. Broselow-Luten System) and/or other patients.

At 602, optionally, the selector 212 selects one or more programs to present to the operator of the apparatus 100 via the display 118 during the imaging procedure. In one instance, the information in the program may indicate that the procedure is going as planned. In another instance, the information may include data relating to a patient position, a state of one or more of the auxiliary devices, a percentage of scan completed and/or to be completed, an estimated radiation dose, etc. In another instance, the information may include a warning, an alert, and/or other notification noting that the imaging procedure is not going as planned. Such a notification may indicate that no signal is being received from an ECG lead and/or that the ECG may have become disconnected.

At 604, optionally, the selector 212 selects one or more programs to present to the operator of the apparatus 100 via the display 118 after the imaging procedure. The information in such a program may relate to conditions that may result in a re-scan, adjustments to scan parameters for a next scan, information about a next imaging acquisition for the patient, a radiation dose delivered, etc. The information may also include information relating to the physiological and/or emotional state of the patient during the scan. Such information may include, but is not limited to, the patient's blood pressure, heart rate, respiratory rate, etc. a degree of patient movement, etc.

The above noted and/or other information can provide guidance to a technician. In another instance, this information can be used to answer technician questions. In another instance, this information can be used to train a technician. In another instance, interaction between the assistant 120 and the technician facilitates training the assistant 120.

It is to be appreciated that one or more of the methods of FIGS. 3-6 can be employed individually and/or in combination.

The above may be implemented by way of computer readable instructions, which when executed by a computer processor(s), cause the processor(s) to carry out the described acts. In such a case, the instructions are stored in a computer readable storage medium associated with or otherwise accessible to the relevant computer.

The invention has been described herein with reference to the various embodiments. Modifications and alterations may occur to others upon reading the description herein. It is intended that the invention be construed as including all such modifications and alterations insofar as they come within the scope of the appended claims or the equivalents thereof.

1. A method, comprising:
presenting, via a display of an imaging apparatus, information for a person interacting with the imaging apparatus.

2. The method of claim 1, wherein the information presented is based on an identification of the person.

3. The method of claim 2, wherein the person is a patient undergoing an imaging examination via the imaging apparatus and wherein the information includes at least one of data about the imaging examination or verification of patient identification

4. The method of claim 2, wherein the information includes patient instructions for the imaging examination, and drives scan protocol selection or a next step of a procedure.

5. The method of claim 2, further comprising:
selecting the information from pre-recorded electronic media based on the identification of the person.

6. The method of claim 2, wherein the information is provided based on a scan protocol for the person.

7. The method of claim 2, further comprising:
enhancing the information with information specific to the person based on the identification.

8. The method of claim 1, wherein the information includes a request of an identification of the person from the person, and further comprising:
receiving a signal indicative of a response to the request from the person, wherein the signal includes the identification of the person.

9. The method of claim 8, further comprising:
comparing the identification in the signal with an identification in an electronic schedule; and
confirming the identification of the person only if the identification in the signal matches the identification from an electronic schedule.

10. The method of claim 9, further comprising:
presenting an alert on the display if the identification in the signal does not match the identification from the electronic schedule.

11. The method of claim 1, further comprising:
presenting, via the display, an instruction to an operator of the imaging apparatus, wherein the instruction relates to an imaging acquisition before, during and/or after the imaging acquisition.

12. The method of claim 1, further comprising:
obtaining patient information;
selecting second information from the pre-recorded electronic media based on the patient information; and
presenting the second information on the display.

13. The method of claim 1, wherein the person is a service technician and the information includes service related information and device history.

14. The method of claim 1, wherein the person is a manufacturing technician and the information includes manufacturing related information.

15. The method of claim 1, wherein the display is physically and electrically integrated with a gantry of the imaging apparatus.

16. The method of claim 1, wherein the display is removably affixed to the imaging apparatus and includes wireless technology for wirelessly communicating with the imaging apparatus when removed from the imaging apparatus.

17. An imaging system, comprising:
an imaging apparatus, including:
a patient examination region; and
a display for presenting information;
a console that controls an operation of the imaging apparatus; and
an electronic assistant that selects one or more programs from pre-recorded electronic media, wherein the one or more programs are presented via the display.

18. The system of claim 17, the display, comprising:
an output region that presents the one or more programs; and
an input region that accepts at least one of audible, optical, or tactile input, wherein the one or more programs are selected based on an input received by the input region.

19. The system of claim 18, wherein the one or more programs request identification information from a patient interacting with the display and the input includes the identification information.

20. The system of claim 19, wherein the electronic assistant confirms the patient's identification based on the input and a patient identification from an electronic schedule.

21. The system of claim 20, wherein the electronic assistant obtains patient information for the patient based on the identification.

22. The system of claim 20, wherein the electronic assistant selects a next one or more programs to present via the display based on at least one of the identification or the patient information.

23. The system of claim 22, wherein the next one or more programs are selected based on a language spoken by the patient.

24. The system of claim 22, wherein the next one or more programs are selected based on an age of the patient.

25. The system of claim 22, wherein the next one or more programs are selected based on an imaging examination scheduled for the patient.

26. The system of claim 25, wherein the next one or more programs includes information about the imaging examination.

27. The system of claim 25, wherein the next one or more programs includes patient instructions for the imaging examination.

28. The system of claim 17, wherein the one or more programs includes a post-imaging examination survey.

29. The system of claim 17, wherein the one or more programs includes at least one of a commercial or an advertisement.

30. The system of claim 17, the imaging apparatus further comprising: a gantry, wherein the display is integrated with the gantry.

31. A computer readable storage medium containing instructions which, when executed by a computer, cause the computer to perform the acts of:
selecting a program to present to a patient of an imaging apparatus based on information about the patient; and
presenting the program via a display of the imaging apparatus.
